(19) United States
(12) Patent Application Publication
(10) Pub. No.: US 2009/0174355 A1
(43) Pub. Date: Jul. 9, 2009

(54) Starting Apparatus for a Direct Current Brushless Motor and Method Thereof

(75) Inventors: Wen-Jung Su, Chupei City (TW); Hsuan-Chuan Chen, Chupei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FEELING TECHNOLOGY CORP., Chupei City (TW)

(21) Appl. No.: 12/348,083

(22) Filed: Jan. 2, 2009

(30) Foreign Application Priority Data
Jan. 8, 2008 (TW) 97100686
Nov. 24, 2008 (TW) 97145344

(51) Int. Cl. H02P 6/20

(52) U.S. Cl. 318/400.33

(57) ABSTRACT

A starting apparatus for a direct current (DC) brushless motor and a method thereof are provided. The DC brushless motor comprises a plurality of windings presenting a joint connection via a common connection. The starting apparatus provides current to two of the three windings and rotates the DC brushless motor to obtain a Back Electro-Motive Force (BEMF) from the floating winding. Then, the starting apparatus provides a current to another two windings to operate the motor according to the variation of BEMF induced by the swing of the motor when it rotates to a static equilibrium point.

This application claims the benefit from the priority of Taiwan Patent Application No. 097100686 filed on Jan. 8, 2008 and Taiwan Patent Application No. 097145344 filed on Nov. 24, 2008, the disclosures of which are incorporated by the later reference herein in their entirety.

### CROSS-REFERENCES TO RELATED APPLICATIONS

Not applicable.

### BACKGROUND OF THE INVENTION

1. Field of the Invention

The present invention relates to a starting apparatus for a direct current (DC) brushless motor and a method thereof. More particularly, this invention relates to a starting apparatus and a method thereof that can start a DC brushless motor without need of a sensor.

2. Descriptions of the Related Art

To detect the correct position of a rotor in a DC brushless motor during the start-up period, the conventional technology is to place a sensor (e.g., a Hall sensor) within the motor. The sensor is configured to sense the variations of a magnetic field between the rotor and the sensor when the motor is running to obtain information of the rotor position. However, the Hall sensor has to be located inside the motor module and placed at the proper position, which appears to increase difficulties in assembly and add production costs to small motors.

DC brushless motors that do not use sensors have been widely adopted in various products requiring a drive force. Generally, for most motors, the speed thereof can be well controlled when running at a medium or high rotational speed. However, when stationary, it is difficult to determine the rotor position, and a particular starting procedure must be implemented to ensure the successful start-up of the motor before entering into the normal driving mode.

Conventional technologies aimed to start a DC brushless motor without the need of a sensor have also been proposed, for example, in U.S. Pat. No. 5,343,127 and U.S. Pat. No. 7,202,623. According to both U.S. patents, a back electromotive force (BEMF) generated across the rotor winding in response to the rotational movement thereof is detected as reference information for determining the rotor position to start the motor. Unfortunately, these technologies require complex operations to start the motor, causing increased difficulties in controlling the motor.

Accordingly, it is important to provide a control method and a circuit thereof that eliminates the need of a sensor while still properly starting a DC brushless motor.

### SUMMARY OF THE INVENTION

One objective of this invention is to provide a method for starting a direct current (DC) brushless motor. The DC brushless motor comprises a plurality of windings jointly connected to each other through a joint juncture. The method comprises the following steps: exciting a first phase by supplying a current to a first winding and a second winding of the windings; measuring a first back electromotive force (BEMF) of a third winding which the current does not flow therethrough; switching to a second phase by switching the current to flow sequentially through the second winding and the third winding according to a start-time period or the determination that the first BEMF exceeds a reference value during the start-time period when a second BEMF of the first winding does not have a current that flows therethrough and crosses a negative zero-crossing point during the second phase. The apparatus then switches to a third phase by switching the current to flow sequentially through the second winding and the first winding.

Another objective of this invention is to provide a starting apparatus of a DC brushless motor. The DC brushless motor comprises a plurality of windings. By supplying a current to two of the windings, the DC brushless motor is rotated to excite a BEMF in the other winding. Then, according to the BEMF variation induced by the swing of the motor when the motor rotates to a static equilibrium point, the current is switched to another two-winding combination, thereby ensuring successful running of the motor.

To achieve the aforementioned objective, this invention provides a starting apparatus of a DC brushless motor. The starting apparatus comprises a control circuit and a detection circuit. The control circuit is configured to excite a first phase by supplying a current to a first winding and a second winding of the windings, and to switch the current to other two-winding combinations in a specified order according to a start-time period or according to the determination that a BEMF of the winding does not have a current that flows therethrough exceeds a reference value during the start-time period to start the DC brushless motor. The detection circuit is configured to measure the BEMF of the winding which the current does not flow therethrough.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of connections between a starting apparatus of this invention and internal windings of a DC brushless motor;

FIGS. 2A and 2B are schematic graphs of magnetic torque waveforms and BEMF waveforms according to an embodiment of this invention; and

FIGS. 3A and 3B are a flowchart of a second embodiment of this invention.

### DESCRIPTION OF THE PREFERRED EMBODIMENT

In the following description, this invention will be explained with reference to embodiments thereof. This invention relates to a starting apparatus for a direct current (DC) brushless motor and a method thereof in which, in response to the BEMF variation induced by the swing of the motor when the rotor rotates to a static equilibrium point, current is supplied to another two-winding combination to ensure the successful running of the motor. However, these embodiments are not intended to limit this invention to any specific context, application or particular implementation described in these embodiments. Therefore, these embodiments are described only for purposes of illustration but not limitation. In the following embodiments and attached drawings, elements unrelated to this invention are omitted from depiction; and, dimensional scales among the individual elements are exaggerated for ease of understanding.

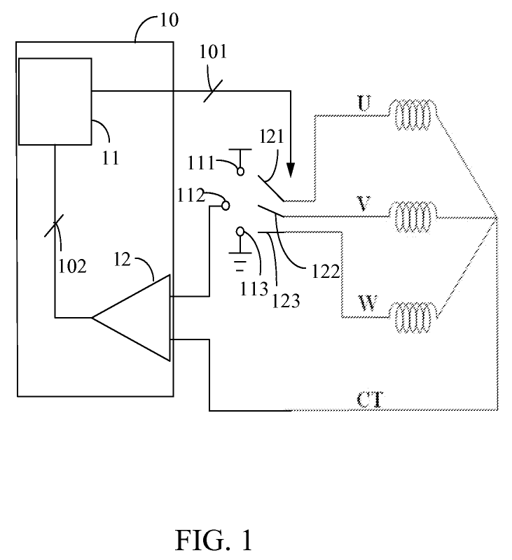

The preferred embodiment of this invention is depicted in FIG. 1, which schematically illustrates a starting apparatus 10 and connections between the starting apparatus 10 and internal windings of a DC brushless motor. In this embodiment, the DC brushless motor is a three-phase motor comprising a winding U, a winding V and a winding W with a central tap CT. The number of windings in the motor is not intended to limit this invention; rather, this invention is applicable to DC brushless motors with three or more windings. The starting apparatus 10 comprises a control circuit 11 and a detection circuit 12. In this embodiment, the control circuit 11 is configured to generate a digital output signal 101, which controls switch elements 121, 122 and 123 disposed between the windings U, V, W and the power supply to regulate the power supplied to these windings.

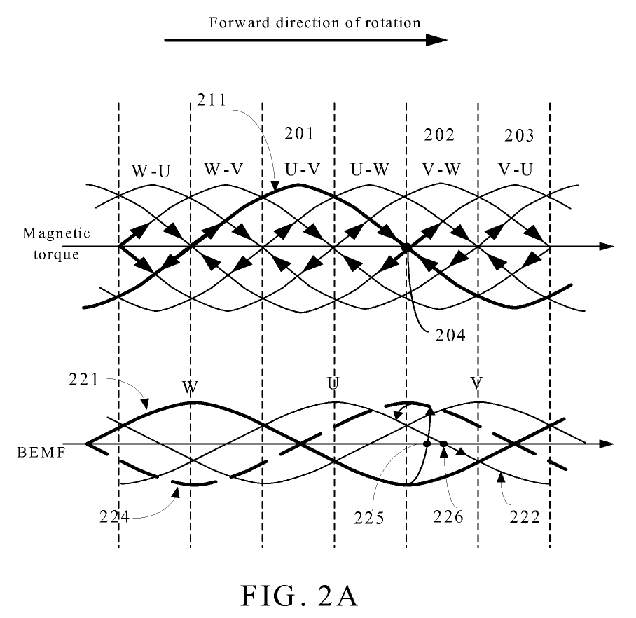

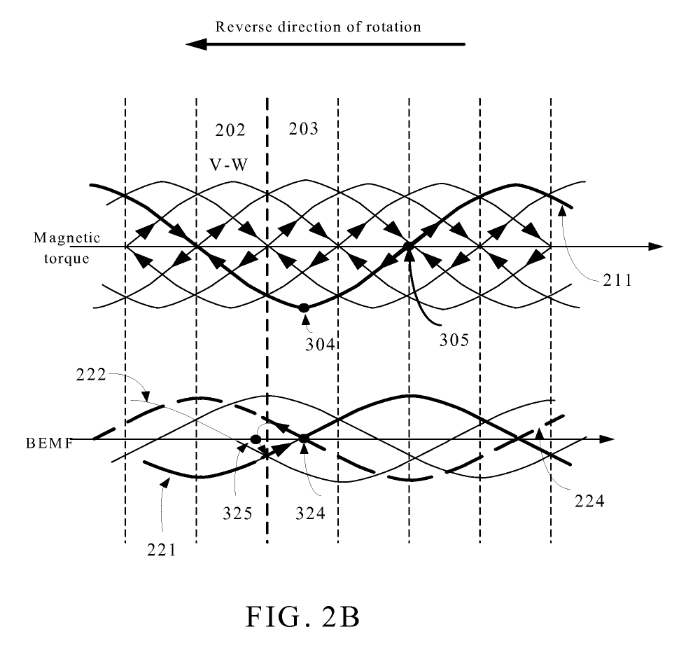

Furthermore, the control circuit 11 receives an output signal 102 from the detection circuit 12, which represents a BEMF generated by a winding which a current does not flow therethrough when the DC brushless motor is running. The detection circuit 12 is configured to measure the BEMF of the winding which a current does not flow therethrough. According to the output signal 102 and a start-time period, the control circuit 11 supplies a current to the windings in a specified order to start the DC brushless motor. In more detail, the control circuit 11 supplies a current flowing sequentially through the first winding and the second winding to excite a first phase, and then according to the start-time period or the determination that the BEMF of the winding does not have a current that flows therethrough (i.e., the third winding) and exceeds a reference value during the start-time period, the starting apparatus 10 switches the current to other two-winding combinations in a specified order shown in FIGS. 2A and 2B to start the DC brushless motor. That is, according to both the first BEMF of the third winding which a current does not flow therethrough and the start-time period, the control circuit 11 switches the current to the second winding and the third winding to switch to a second phase.

For example, the windings U, V and W are connected to the power supply terminal 111, an input terminal 112 of the detection circuit 12 and a ground terminal 113 respectively through switching on the switch elements 121, 122 and 123 by the control circuit 11. The digital output signal 101 is adapted to control the connection relationships between the windings U, W and V and the power supply terminal 111, an input terminal 112 of the detection circuit 12 and a ground terminal 113. For example, when the winding U is connected to the power supply terminal 111 and the winding V is connected to the ground terminal 113, the winding W will be connected to the input terminal 112, in which case the BEMF generated across the winding W is just the input signal of the detection circuit 12.

The control circuit 11 further comprises a delay circuit (not shown) configured to generate a delay time. The length of the delay time is adapted to prevent the control circuit 11 from determining that a pseudo BEMF crosses either a positive zero-crossing or a negative zero-crossing.

In more detail, the control circuit 11 determines whether the first BEMF crosses the positive zero-crossing point during the start-time period. If the first BEMF crosses the positive zero-crossing point, the current is switched to flow sequentially through the second winding and the third winding to switch to a second phase. Otherwise, after the elapse of the start-time period, the current is switched to flow sequentially through the second winding and the third winding to switch to the second phase.

Subsequent to switching to the second phase, the detection circuit 12 detects the second BEMF of the first winding in which a current does not flow therethrough, and the control circuit 11 switches the current to the second winding and the first winding when the second BEMF crosses a negative zero-crossing point to switch to a third phase. Thus, the starting process of the DC brushless motor is accomplished.

FIG. 2A illustrates a waveform diagram of magnetic torque and BEMF is illustrated therein to more clearly explain how the starting apparatus 10 starts the DC brushless motor. The waveform diagram includes the magnetic torque waveforms and the BEMF waveforms, and defines the forward direction of rotation. For example, with the windings U (i.e., the aforementioned first winding) and V (i.e., the aforementioned second winding), the switch elements 121, 122 are coupled to the power supply terminal 111 and the ground terminal 113 respectively, and the central tap CT is coupled to the detection circuit 12 to complete a circuit, so that the control circuit 11 supplies a current to the windings U, V via the power terminal 111 to excite the U-V phase 201 (i.e., the aforementioned first phase). The magnetic torque of the U-V phase 201 is denoted as a curve 211. The switch element 123 is coupled to the input terminal 112 so that no current flows through the winding W presently. In other words, the first BEMF (i.e., a curve 221) will be generated across the winding W. It should be noted that if the current is supplied to the windings U and V continuously, the static equilibrium point 204 can be observed on the magnetic-torque curve 211. This is a characteristic of the DC brushless motors; that is, once the rotor rotates to the static equilibrium point 204, it will come to a standstill and cease to rotate at the static equilibrium point 204. This invention just drives a DC brushless motor by virtue of this characteristic.

Furthermore, the detection unit 12 detects the variations of the first BEMF continuously. When the rotor rotates the static equilibrium point 204, it is rotating in the forward direction, and due to the inertia, the rotor will rotate towards the forward direction a little further before rotating in the reverse direction. At this point, the detection unit 12 will detect the first BEMF of the reverse direction (i.e., the curve 224). Because the BEMF varies on a continuous basis, the BEMF detected by the detection unit 12 at this point will abruptly jump from the curve 221 to the curve 224, thereby giving rise to the positive zero-crossing point 225. Hence, according to the output signal 102 from the detection circuit 12, the control circuit 11 switches the current to flow sequentially through the windings V (i.e., the second winding) and W (i.e., the third winding), i.e., to switch to the V-W phase 202 (i.e., the aforementioned second phase). Then, the detection circuit 12 can detect the second BEMF of the winding U (i.e., the curve 222). Arrows before and after the positive zero-crossing point 225 in FIG. 2A are illustrated to assist in the further understanding of the aforementioned variations of the BEMF.

After the current is switched to the V-W phase 202, the control circuit 11 determines whether the BEMF curve 222 crosses a negative zero-crossing 226 according to the output signal 102. If the BEMF curve 222 crosses a negative zero-crossing 226, the current is switched to flow sequentially through the windings V and U, i.e., switched to the V-U phase 203 (i.e., the aforementioned third phase) so that the motor can enter the normal driving mode after starting the DC brushless motor.

Furthermore, it is also possible that when being started, the rotor of the DC brushless motor rotates in the reverse direction according to the magnetic torque of the U-V phase 201 (i.e., the curve 211). In referring to FIG. 1 and FIG. 2B together, when subjected to the action of the magnetic torque shown between the points 304 and 305 on the curve 211, the rotor rotates in the reverse direction, in which case the detection unit 12 detects the first BEMF in the reverse direction (i.e., the curve 224) of the winding W which a current does not flow therethrough. If the current is supplied to the windings U and V continuously, the first BEMF of the winding W will cross a positive zero-crossing point 324 when the rotor rotates beyond the point 304, in which case the control circuit 11 switches the current to flow sequentially through the windings V and W (i.e., the third winding) according to the output signal 102 from the detection circuit 12 to switch the current to the V-W phase 202. Then, the detection circuit 12 can detect the second BEMF of the winding U (i.e., the curve 222). It can be seen from the BEMF waveforms shown in FIG. 2B that a negative zero-crossing 325 occurs when the BEMF changes from the curve 224 to the curve 222. Then, according to the output signal 102, the control circuit 11 determines that the negative zero-crossing has occurred and then switches the current to flow sequentially through the windings V and U, i.e., to the V-U phase 203, so that the motor enters the normal driving mode once started as described above.

In reference to FIG. 2A, it is also possible that the rotor of the DC brushless motor already stays at the static equilibrium point 204 in the stationary state, in which case exciting the U-V phase 201 will fail to rotate the rotor. Therefore, if the first BEMF does not cross the positive zero-crossing point during the start-time period, the control circuit 12 will switch the current to the windings V and W, i.e., to the V-W phase 202, and then proceed with the aforementioned operations.

With the above arrangement of this invention, by supplying a current to two of the windings of the DC brushless motor, the DC brushless motor is rotated in the forward direction to excite a BEMF in the other winding. Then, in response to the variation of the BEMF induced by the swing of the motor when the motor rotates to the static equilibrium point, the current is switched to another two-winding combination to ensure successful running of the motor. In this way, a complex operational procedure is not needed to start the motor.

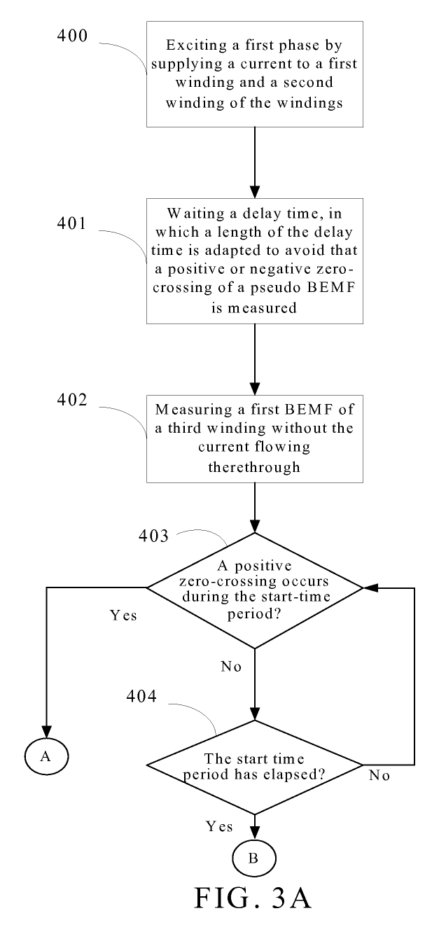

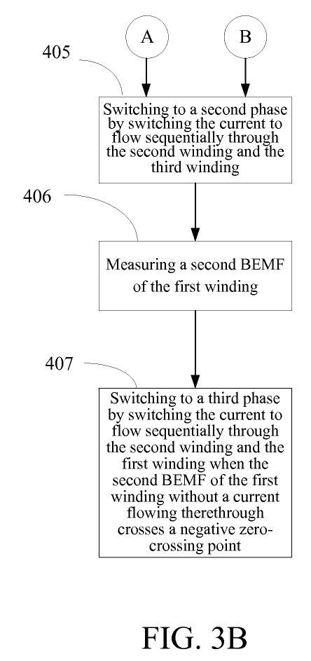

The second preferred embodiment of this invention is depicted in FIGS. 3A and 3B, which jointly depict the flow diagram of a method for starting a DC brushless motor. The DC brushless motor comprises a plurality of windings jointly connected to each other through a joint juncture. This method comprises the following steps. Initially, in reference to FIG. 3A, step 400 is executed to excite a first phase by supplying a current to a first winding and a second winding of the windings. Then, step 401 is executed to wait a delay time, in which the length of the delay time is adapted to avoid that a pseudo BEMF crosses either a positive zero-crossing point or a negative zero-crossing point. This is because the erroneous noise signals that are possibly generated when the DC brushless motor is started might cause a pseudo positive or pseudo negative zero-crossing of the BEMF, so a delay time is necessary to prevent this phenomenon from interfering with the starting process of the motor.

Next, step 402 is executed to measure the first BEMF of a third winding which the current does not flow therethrough. Then, step 403 is executed to determine whether the positive zero-crossing occurs during the start-time period, i.e., whether the first BEMF exceeds a reference value. If the positive zero-crossing occurs during the start-time period, step 405 is executed to switch to a second phase by switching the current to flow sequentially through the second winding and the third winding; otherwise, if the positive zero-crossing does not occur during the start-time period, step 404 is executed to determine whether the start-time period has elapsed. If the start-time period has elapsed, then step 405 is executed; otherwise, step 403 is repeated.

Next, step 406 is executed to measure a second BEMF of the first winding, and step 407 is executed to switch to a third phase by switching the current to flow sequentially through the second winding and the first winding when the second BEMF of the first winding does not have a current that flows therethrough and crosses the negative zero-crossing point. Now, the DC brushless motor has been started successfully to enter the normal driving mode. The normal driving mode will be understood by those skilled in the art upon reviewing FIGS. 2A and 2B and thus will not be further described herein.

In addition to the steps depicted in FIGS. 3A and 3B, the second preferred embodiment may also execute all the operations and functionalities of the first preferred embodiment. Those of ordinary skill in the art may readily understand how the second preferred embodiment executes these operations and functionalities based on the descriptions of the first preferred embodiment. Thus, this will not be further described herein.

Accordingly, according to the variation of BEMF induced by the swing of the motor when the motor rotates to a static equilibrium point, this invention supplies a current to another two-winding combination to ensure the successful running of the motor. This reduces the cost by eliminating the disposition of the Hall sensors and ensuring a proper and fast start of the DC brushless motor.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for starting a direct current (DC) brushless motor, the DC brushless motor comprising a plurality of windings jointly connected to each other through a joint juncture, the method comprising the following steps of:
(a) exciting a first phase by supplying a current to flow sequentially through a first winding and a second winding of the windings;
(b) measuring a first back electromotive force (BEMF) of a third winding which the current does not flow therethrough;
(c) switching to a second phase by switching the current to flow sequentially through the second winding and the third winding according to a start-time period or a determination that the first BEMF exceeds a reference value during the start-time period; and
(d) when a second BEMF of the first winding which the current does not flow therethrough crosses a negative zero-crossing point during the second phase, switching to a third phase by switching the current to flow sequentially through the second winding and the first winding.

2. The method as claimed in claim 1, further comprising, prior to the step (b), a step of:
waiting a delay time during which the first BEMF is not measured, wherein a length of the delay time is adapted to avoid that a pseudo BEMF crosses one of a positive zero-crossing point and a negative zero-crossing point.

3. The method as claimed in claim 1, wherein the step (c) comprises:
switching to the second phase by switching the current to flow sequentially through the second winding and the third winding while the first BEMF crosses a positive zero-crossing point during the start-time period.

4. The method as claimed in claim 1, wherein the step (c) comprises:
switching to the second phase by switching the current to flow sequentially through the second winding and the third winding after the start-time period has elapsed while the first BEMF does not crosses a positive zero-crossing point during the start-time period.

5. An apparatus for starting a DC brushless motor, the DC brushless motor comprising a plurality of windings, the apparatus comprising:
a detection circuit coupled to the windings, being configured to measure a BEMF of a winding which a current does not flow therethrough, so as to generate an output signal; and
a control circuit coupled to the windings and the detection circuit to receive the output signal of the detection circuit, being configured to excite a first phase by supplying a current to flow sequentially through a first winding and a second winding of the windings, and to switch the current to other two-winding combinations among the windings in a specified order according to a start-time period or a determination that the first BEMF of the winding which the current does not flow therethrough exceeds a reference value during the start-time period, so as to start the DC brushless motor.

6. The apparatus as claimed in claim 5, wherein according to a start-time period or a determination that a first BEMF of a third winding which the current does not flow therethrough exceeds a reference value during the start-time period, the control circuit switches to a second phase by switching the current to flow sequentially through the second winding and the third winding; and wherein during the second phase, the detection circuit detects a second BEMF of the first winding which the current does not flow therethrough, and the control circuit switches to a third phase by switching the current to flow sequentially through the second winding and the first winding when the second BEMF crosses a negative zero-crossing point.

7. The apparatus as claimed in claim 6, wherein the control circuit switches to the second phase by switching the current to flow sequentially through the second winding and the third winding when the first BEMF crosses a positive zero-crossing point during the start-time period.

8. The apparatus as claimed in claim 6, wherein the control circuit switches to the second phase by switching the current to flow sequentially through the second winding and the third winding after the start-time period has elapsed while the first BEMF does not crosses a positive zero-crossing point during the start-time period.

9. The apparatus as claimed in claim 5, wherein the control circuit further comprises a delay circuit configured to generate a delay time, and a length of the delay time is adapted to avoid that the control circuit determines a pseudo BEMF occurring a positive zero-crossing or a negative zero-crossing.
